(19) United States
(12) Patent Application Publication
(10) Pub. No.: US 2010/0157624 A1
(43) Pub. Date: Jun. 24, 2010

(54) Light Guide Plate and Backlight Module

(75) Inventors: Chun-CHien Liao, Hsin-Chu (TW); Tzeng-Ke Shiau, Hsin-Chu (TW)

Correspondence Address: Portal IPR Services, P.O. box 223205, Chantilly, VA, 20153, US

(73) Assignee: Coretronic Corporation

(21) Appl. No.: 12/641,295

(22) Filed: Dec. 17, 2009

(30) Foreign Application Priority Data
Dec. 24, 2008 (TW) 097150505

(51) Int. Cl. F21V 7/04

(52) U.S. Cl. 362/611; 362/616

(57) ABSTRACT

A light guide plate includes a first light guide body having a light incident plane, a first connection surface, and recesses and a second light guide body having a light emitting plane, a second connection surface opposite to the light emitting plane, and protrusions. The recesses are disposed on the first connection surface. Each of the recesses has a bottom plane parallel to the light emitting plane. The light incident plane intersects with the first connection surface. The first connection surface contacts the second connection surface. The protrusions are disposed on the second connection surface and fill the recesses respectively. Cross-sectional planes of each protrusion parallel to the light emitting plane decrease gradually in a direction towards the bottom plane of the corresponding recess. A terminal thickness of the second light guide body is less than that of the first one.

### CROSS-REFERENCES

This application claims priority to Taiwan application No. 097150505 filed on Dec. 24, 2008.

### BACKGROUND

1. Technical Field

The invention generally relates to a light guide plate, and more specifically, to a backlight module having the light guide plate.

2. Description of the Related Art

FIG. 1 is a schematic side view of a conventional backlight module. Referring to FIG. 1, the conventional backlight module M1 includes a light guide plate 100 and a light source N1. The light guide plate 100 has a light incident plane 110, a light emitting plane 120, a bottom surface 130, and a plurality of prism patterns 140. The light incident plane 110 is perpendicular to the light emitting plane 120, and the light emitting plane 120 is opposite to the bottom surface 130. Furthermore, the light source N1 is disposed beside the light incident plane 110.

The prism patterns 140 are disposed on the light emitting plane 120, and each of the prism patterns 140 extends in a direction. The direction is parallel to the light incident plane 110 and the light emitting plane 120. The shape of a cross-sectional plane 142 of each of the prism patterns 140 is an obtuse triangle, and the cross-sectional plane 142 of each of the prism patterns 140 is perpendicular to the light incident plane 110 and the light emitting plane 120. One of two sides of the obtuse angle of the cross-sectional plane 142 of each of the prism patterns 140 is disposed on the light emitting plane 120, and the other of the two sides of the obtuse angle of the cross-sectional plane 142 of each of the prism patterns 140 is the shortest side of the obtuse triangle. When the backlight module M1 operates, a light beam L1 emitted by the light source N1 is reflected by the bottom surface 130 of the light guide plate 110 and enters one of these prism patterns 140. The light beam L1 is emitted outside in a direction almost perpendicular to the light emitting plane 120 after having been totally reflected twice in the corresponding prism pattern 140.

However, the light beam L1 may enter the corresponding prism pattern 140 with a specific angle, so that the light beam L1 may be emitted outside in the direction almost perpendicular to the light emitting plane 120. Thus, the brightness of the conventional backlight module M1 is low at the direction perpendicular to the light emitting plane 120 of the light guide plate 100. Furthermore, the prism patterns 140 of the conventional light guide plate 100 are difficult to be manufactured. Additionally, the prism patterns 140 of the conventional light guide plate 100 are prone to scrape and damage optical films (not shown) disposed above the light emitting plane 120 of the light guide plate 100. The prism patterns 140 of the conventional light guide plate 100 are also prone to be pressed to be deformed by other components (not shown) disposed above the light emitting plane 120 of the light guide plate 100.

### BRIEF SUMMARY

The invention is directed to provide a light guide plate so that the brightness of a backlight module with the light guide plate is high at a direction perpendicular to a light emitting plane of the light guide plate.

The invention is directed to provide a backlight module, and the brightness of the backlight module is high at a direction perpendicular to a light emitting plane of a light guide plate thereof.

Other advantages and objectives of the invention may be further comprehended through the technical features disclosed in the invention.

In order to achieve one or part of or all the objectives or other objectives, in an embodiment of the invention, a light guide plate includes a first light guide body and a second light guide body. The first light guide body has a light incident plane, a first connection surface, and a plurality of recesses. The recesses are disposed on the first connection surface. Each of the recesses has a bottom plane. The light incident plane intersects with the first connection surface. The second light guide body has a light emitting plane, a second connection surface, and a plurality of protrusions. The light emitting plane is opposite to the second connection surface. The first connection surface contacts the second connection surface. The bottom plane of each of the recesses is substantially parallel to the light emitting plane. The protrusions are disposed on the second connection surface and fill the recesses respectively. A plurality of first cross-sectional planes of each of the protrusions substantially parallel to the light emitting plane decrease gradually in a first direction towards the bottom plane of the corresponding recess. The first direction is perpendicular to the light emitting plane. A terminal thickness of the second light guide body is less than a terminal thickness of the first light guide body. The refractive index of the second light guide body is greater than the refractive index of the first light guide body.

In order to achieve one or part of or all the objectives or other objectives, in an embodiment of the invention, a backlight module includes the above light guide plate and a light source. The light source is disposed beside the light incident plane of the light guide plate.

The embodiment or the embodiments of the invention may have at least one of the following advantages. Since the first light guide body of the light guide plate has a plurality of recesses and each of the recesses has a bottom plane, the bottom plane of each of the recesses may avoid the corresponding light beam with improper incidence angle totally entering the corresponding protrusion of the second light guide body when the light beams entering the first light guide body travel to the bottom planes of the recesses. As a result, part of each of the light beams with improper incidence angle emitting from the light emitting plane is decreased.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic side view of a conventional backlight module.

FIG. 2A is a schematic top view of a backlight module according to a first embodiment of the invention

FIG. 2B is a schematic cross-sectional view of the backlight module of FIG. 1 taken along line A-A of FIG. 1.

FIG. 2C schematically shows the transmission paths of light beams in the light guide plate of FIG. 2B.

FIG. 3 is a schematic cross-sectional view of a backlight module according to a second embodiment of the invention.

FIG. 4 is a schematic cross-sectional view of a backlight module according to a third embodiment of the invention.

FIG. 5 is a schematic cross-sectional view of a backlight module according to a fourth embodiment of the invention.

FIG. 6 is a schematic cross-sectional view of a backlight module according to a fifth embodiment of the invention.

FIG. 7A is a schematic top view of a backlight module according to a sixth embodiment of the invention.

FIG. 7B is a schematic cross-sectional view of the backlight module of FIG. 7A taken along line B-B of FIG. 7A.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

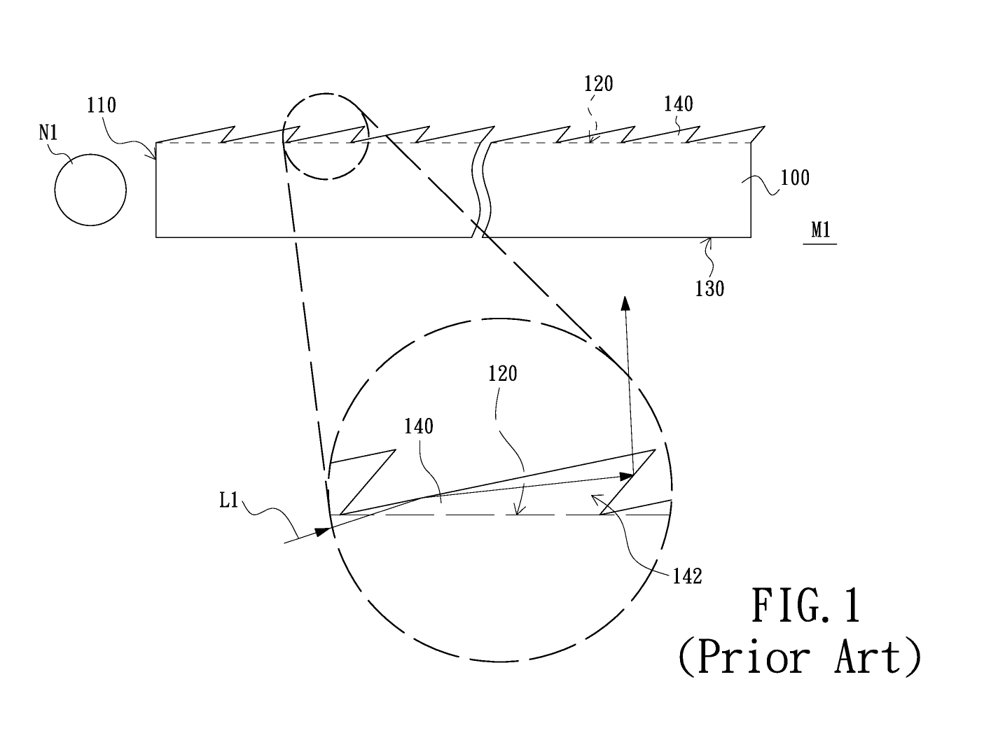

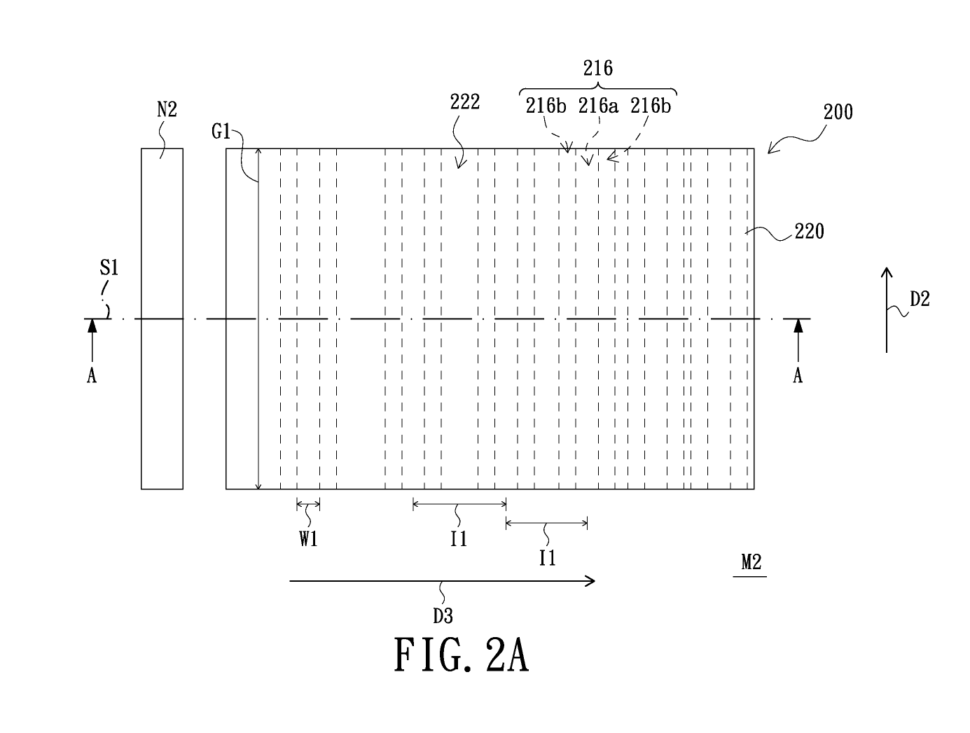

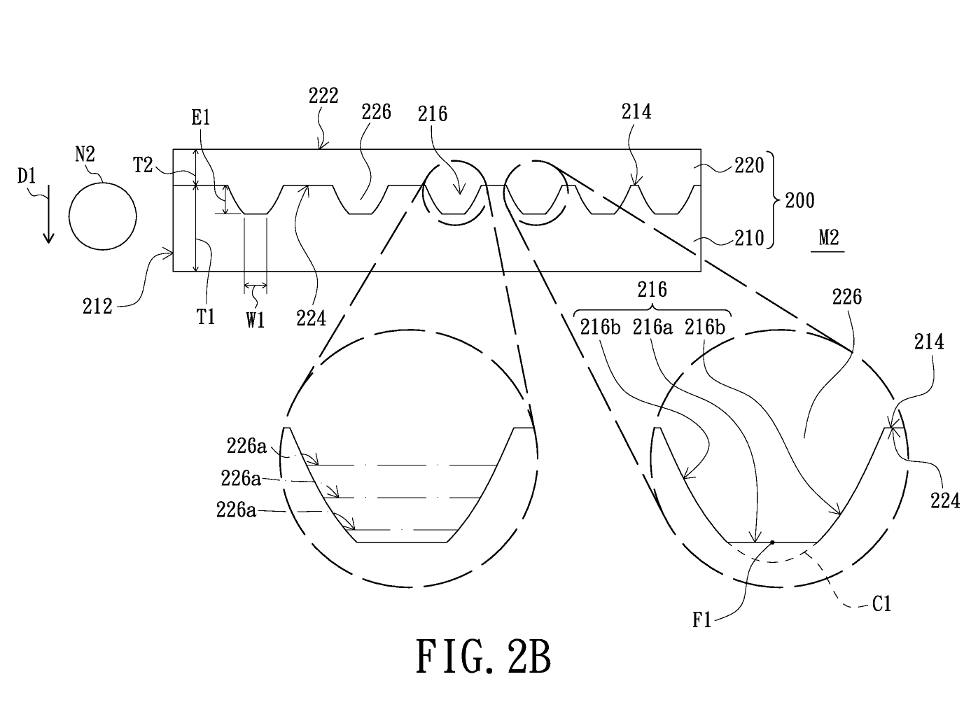

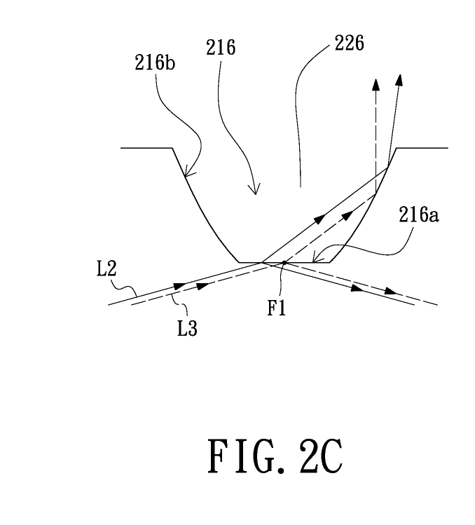

FIG. 2A is a schematic top view of a backlight module according to a first embodiment of the invention, and FIG. 2B is a schematic cross-sectional view of the backlight module of FIG. 1 taken along line A-A of FIG. 1. Referring to FIGS. 2A-2B, the backlight module M2 of this embodiment includes a light guide plate 200 and a light source N2. The light guide plate 200 includes a first light guide body 210 (such as a plate-shaped light guide body) and a second light guide body 220 (such as a plate-shaped light guide body). The first light guide body 210 has a light incident plane 212, a first connection surface 214, and a plurality of recesses 216. The light incident plane 212 intersects with the first connection surface 214, and the light source N2 is disposed beside the light incident plane 212. These recesses 216 are disposed on the first connection surface 214. Each of the recesses 216 has a bottom plane 216a and two opposite side surfaces 216b. The bottom plane 216a of each of the recesses 216 connects the two side surfaces 216b of the same recess 216. In other words, in each of the recesses 216, the bottom plane 216a connects the two side surfaces 216b.

The second light guide body 220 has a light emitting plane 222, a second connection surface 224, and a plurality of protrusions 226. The light emitting plane 222 is opposite to the second connection surface 224. The first connection surface 214 contacts the second connection surface 224. In this embodiment, the light incident plane 212 of the first light guide body 210 is substantively perpendicular to the light emitting plane 222 of the second light guide body 220.

The bottom plane 216a of each of the recesses 216 is substantively parallel to the light emitting plane 222. The protrusions 226 are disposed on the second connection surface 224 and fill the recesses 216 respectively. A plurality of first cross-sectional planes 226a of each of the protrusions 226 parallel to the light emitting plane 222 decrease gradually in a first direction D1 towards the bottom plane 216a of the corresponding recess 216. The first direction D1 is perpendicular to the light emitting plane 222. Furthermore, a terminal thickness T2 of the second light guide body 220 is less than a terminal thickness T1 of the first light guide body 210. In this embodiment, the specific value calculated by dividing the terminal thickness T1 of the first light guide body 210 by the terminal thickness T2 of the second light guide body 220 is between 10 and 100. Additionally, the refractive index of the second light guide body 220 is greater than the refractive index of the first light guide body 210. In this embodiment, the absolute value of the difference between the refractive index of the second light guide body 220 and the refractive index of the first light guide body 210 is between 0.03 and 0.4.

Since the recesses 216 and the protrusions 226 are located inside of the light guide plate 200, compared with the conventional art, the recesses 216 and the protrusions 226 of the light guide plate 200 do not scrape and damage optical films (not shown) disposed above the light emitting plane 222 of the light guide plate 200. The recesses 216 and the protrusions 226 of the light guide plate 200 are not pressed to be deformed by other components (not shown) disposed above the light emitting plane 222 of the light guide plate 200.

The profile of each of the recesses 216 will be described in details. In this embodiment, each of the recesses 216 is a groove and extends in a second direction D2 parallel to the light incident plane 212. The length G1 of the bottom plane 216a of each of the recesses 216 is parallel to the light incident plane 212. The specific value calculated by dividing the width W1 of the bottom plane 216a of each of the recesses 216 by the depth E1 of the same recess 216 is between 0.1 and 10.

The side surfaces 216b of each of the recesses 216 are curved surfaces, and the side surfaces 216b of each of the recesses 216 are symmetric to each other. Furthermore, the side surfaces 216b of each of the recesses 216 and a second cross-sectional plane S1 intersect with each other to form a locus, and the locus is two parts of a parabola C1. The second cross-sectional plane S1 is perpendicular to the light emitting plane 222 and the light incident plane 212, and the bottom plane 216a of each of the recesses 216 passes the focus F1 of the corresponding parabola C1. Additionally, an interval I1 is defined between each two adjacent recesses 216 and the intervals I1 decrease gradually in a third direction D3 away from the light incident plane 212 of the first light guide body 210.

The light guide plate 200 may be manufactured in the following method. First, the first light guide body 210 may be manufactured through thermal compression process or injection molding process. In other embodiment, the first light guide body 210 may be manufactured by means of coating and solidification. Then, the second light guide body 220 may be manufactured by means of coating and solidification so that the protrusions 226 may closely contact the recesses 216 respectively.

Since the first cross-sectional planes 226a of each of the protrusions 226 of the light guide plate 200 parallel to the light emitting plane 222 decrease gradually in the first direction D1 towards the bottom plane 216a of the corresponding recess 216, the light guide plate 200 is easily manufactured compared with the conventional art.

The transmission paths of light beams in the light guide plate 200 will be described herein, more particularly, one of the recesses 216 and one of the protrusions 226 are taken as an example to describe the detailed. FIG. 2C schematically shows the transmission paths of light beams in the light guide plate of FIG. 2B. Referring to FIGS. 2B-2C, when a light beam L2 entering the first light guide body 210 travels to the bottom plane 216a of the recess 216, one part of the light beam L2 is reflected and another part of the light beam L2 is refracted into the protrusion 226 of the second light guide body 220. Accordingly, the bottom plane 216a of the recess 216 may avoid the light beam L2 with improper incidence angle totally entering the protrusion 226 of the second light guide body 226 such that part of the light beam L2 with improper incidence angle emitting from the light emitting plane 222 is decreased.

When a light beam L3 entering the first light guide body 210 travels to the bottom plane 216a of the recess 216 and passes the focus F1 of the corresponding parabola C1, part of the light beam L3 is refracted into the protrusion 226 of the second light guide body 220 and then totally reflected at one of the side surfaces 216b of the recess 216 so that the part of the light beam L3 is emitted outside in a direction perpendicular to the light emitting plane 222. Thus, taken as a whole, the brightness of the backlight module M2 compared with the conventional art is high at the direction perpendicular to the light emitting plane 222 of the light guide plate 200.

It should be understood that the side surfaces 216b of each of the recesses 216 may be designed to be a flat surface or other curved surfaces according to the requirements of designers, and the side surfaces 216b of each of the recesses 216 may be symmetric or dissymmetrical. However, these situations are not shown in the drawings.

### Second Embodiment

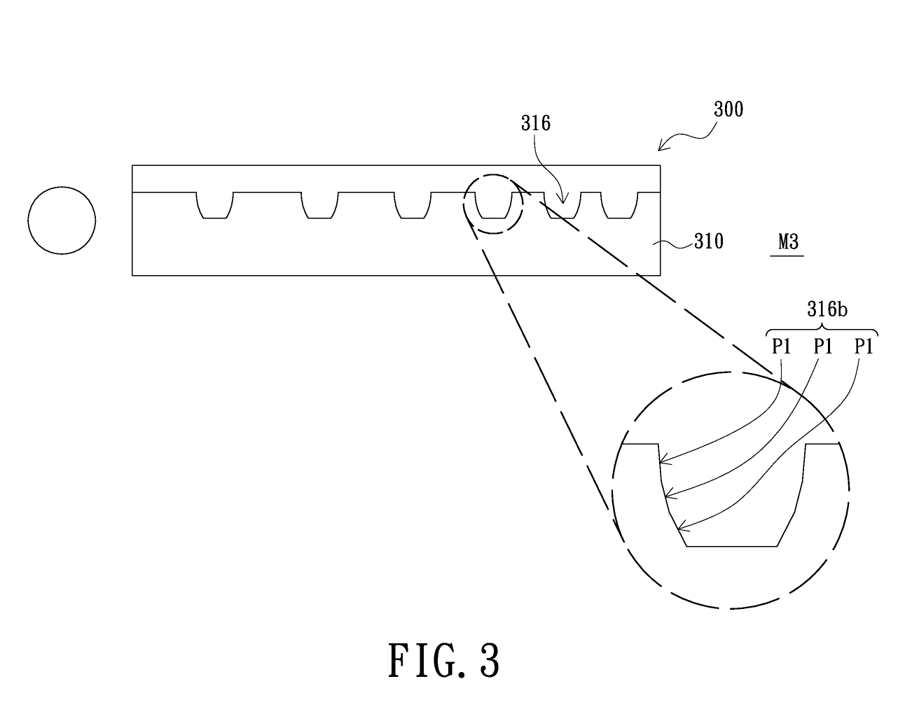

FIG. 3 is a schematic cross-sectional view of a backlight module according to a second embodiment of the invention. Referring to FIGS. 2B-3, the difference between the backlight module M3 of this embodiment and the backlight module M2 of the first embodiment is that each of the side surfaces 316b of each of the recesses 316 of a first light guide body 310 of a light guide plate 300 of the backlight module M3 includes several flat surfaces P1. In another embodiment, each of the side surfaces 316b of each of the recesses 316 of a light guide plate 300 of the backlight module M3 may include several curved surfaces (not shown) according to requirements of designers.

### Third Embodiment

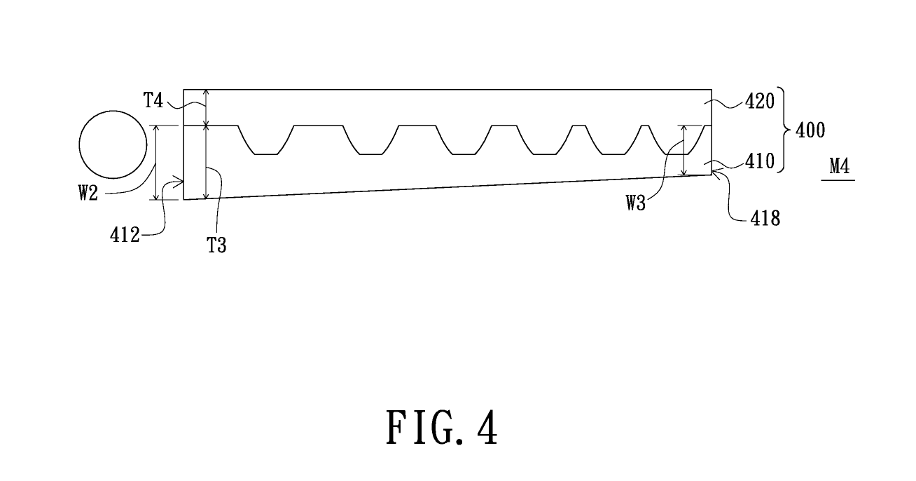

FIG. 4 is a schematic cross-sectional view of a backlight module according to a third embodiment of the invention. Referring to FIGS. 2B and 4, the difference between the backlight module M4 of this embodiment and the backlight module M2 of the first embodiment is that a first light guide body 410 of a light guide plate 400 of the backlight module M4 is a wedge-shaped light guide body and a second light guide body 420 is a plate-shaped light guide body. A thickness T3 of the first light guide body 410 has a maximum value and a minimum value. The maximum value of the thickness T3 of the first light guide body 410 equals to a width W2 of a light incident plane 412 of the first light guide body 410 (hereinafter to be referred as “maximum terminal thickness W2” for short). The minimum value of the thickness T3 of the first light guide body 410 equals to a width W3 of an end surface 418 of the first light guide body 410 opposite to the light incident plane 412 (hereinafter to be referred as “minimum terminal thickness W3” for short).

In this embodiment, the specific value calculated by dividing the maximum terminal thickness W2 of the first light guide body 410 by a terminal thickness T4 of the second light guide body 420 is between 10 and 100. The specific value calculated by dividing the minimum terminal thickness W3 of the first light guide body 410 by the terminal thickness T4 of the second light guide body 420 is between 3 and 30.

### Fourth Embodiment

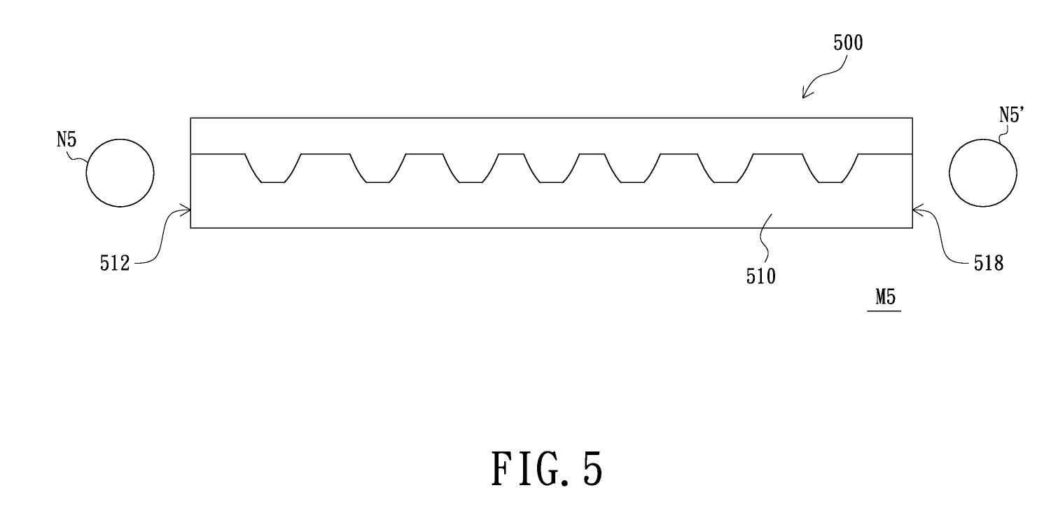

FIG. 5 is a schematic cross-sectional view of a backlight module according to a fourth embodiment of the invention. Referring to FIGS. 2B and 5, the difference between the backlight module M5 of this embodiment and the backlight module M2 of the first embodiment is that the backlight module M5 includes two light sources N5 and N5′ and a first light guide body 510 of a light guide plate 500 further has another light incident plane 518. The light sources N5 and N5′ are disposed beside the light incident planes 512 and 518, respectively.

### Fifth Embodiment

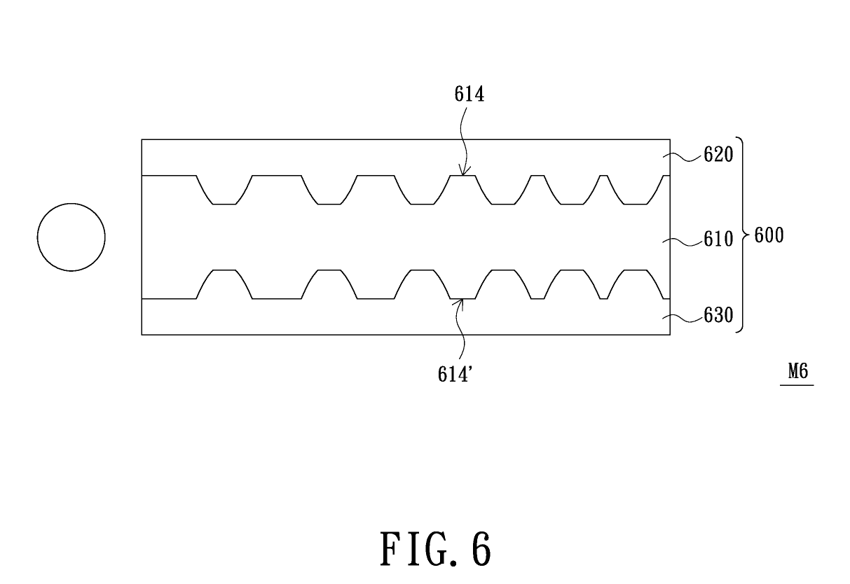

FIG. 6 is a schematic cross-sectional view of a backlight module according to a fifth embodiment of the invention. Referring to FIGS. 2B and 6, the difference between the backlight module M6 of this embodiment and the backlight module M2 of the first embodiment is that a light guide plate 600 of the backlight module M6 further includes a third light guide body 630 disposed on a third connection surface 614′ of a first light guide body 610. The first connection surface 614 and the third connection surface 614′ of the first light guide body 610 are opposite to each other. The shape of the third light guide body 630 is the same as the shape of a second light guide body 620, and the third light guide body 630 and the second light guide body 620 are symmetric to each other.

### Sixth Embodiment

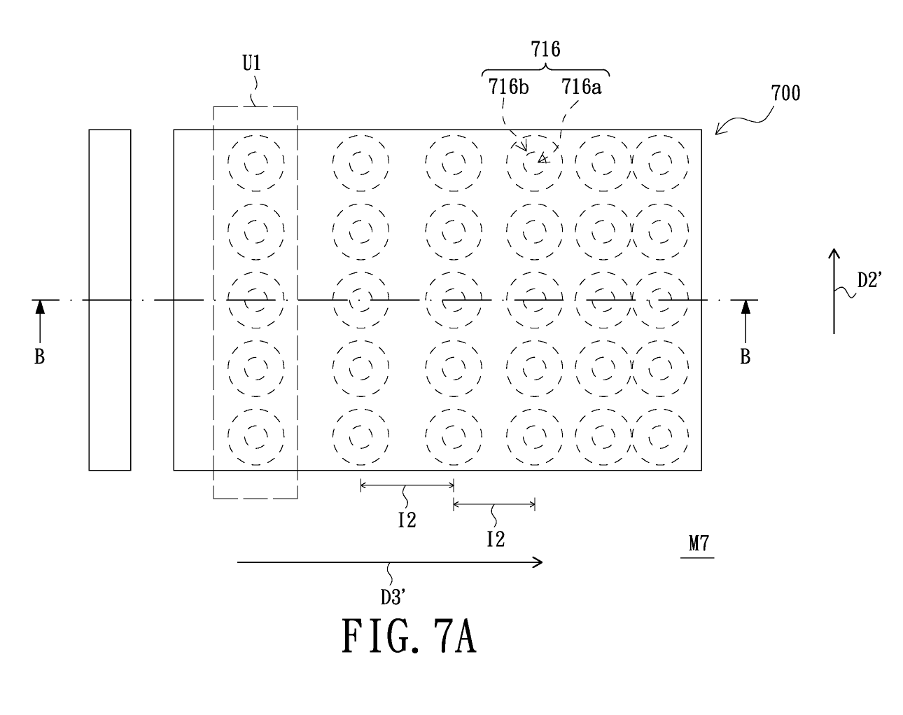

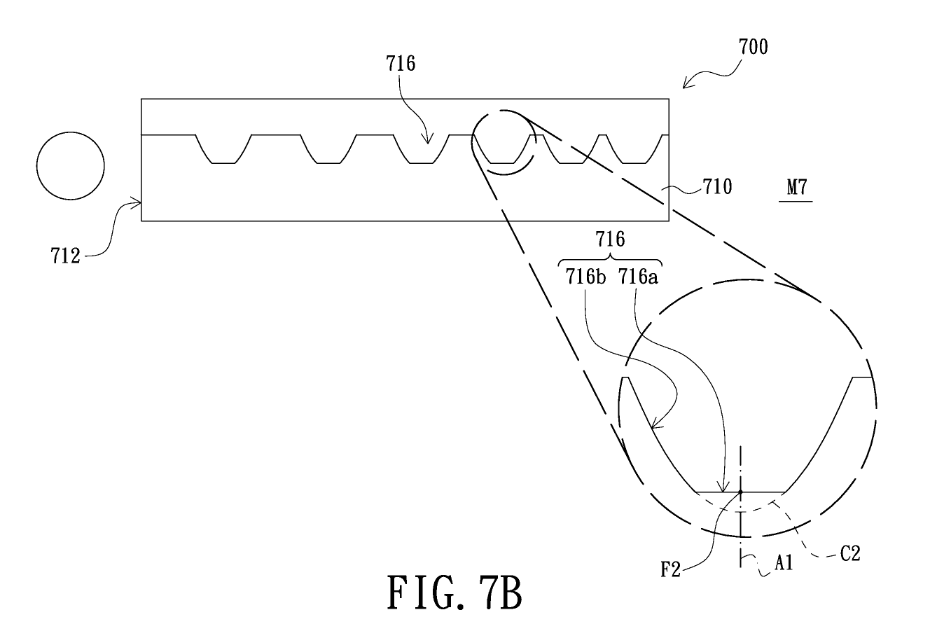

FIG. 7A is a schematic top view of a backlight module according to a sixth embodiment of the invention. FIG. 7B is a schematic cross-sectional view of the backlight module of FIG. 7A taken along line B-B of FIG. 7A. Referring to FIGS. 2A, 2B, 7A-7B, the difference between the backlight module M7 of this embodiment and the backlight module M2 of the first embodiment is that the shape of each of the recesses 716 of a first light guide body 710 of a light guide plate 700 of the backlight module M7 is different from the shape of each of the recesses 216 of the light guide plate 200 of the backlight module M2.

In this embodiment, each of the recesses 716 is a hole. A plurality of recess groups U1 are composed of the recesses 716. The recesses 716 of each of the recess groups U1 are arranged in a second direction D2′ parallel to a light incident plane 712. Furthermore, an interval I2 is defined between each two adjacent recess groups U1. The intervals I2 decrease gradually in a third direction D3′ away from the light incident plane 712.

Each of the recesses 716 of this embodiment includes a bottom plane 716a and a side surface 716b encircling the bottom plane 716a. The side surface 716b of each of the recesses 716 is part of a circular paraboloid C2. The bottom plane 716a of each of the recesses 716 is perpendicular to a symmetry axis A1 of the side surface 716b of the same recess 716, and passes the focus F2 of the corresponding circular paraboloid C2. It should be understood that the circular paraboloid C2 of this embodiment is defined as a curved surface formed via rotating a parabola around about the symmetry axis A1. Furthermore, the side surface 716b of each of the recesses 716 may be designed to be part of a spheroid or part of a right circular conical surface (not shown) according to requirements of the designers.

The embodiment or the embodiments of the invention may have at least one of the following advantages.

First, since the first light guide body of the light guide plate has a plurality of recesses and each of the recesses has a bottom plane, the bottom plane of each of the recesses may avoid the corresponding light beam with improper incidence angle totally entering the corresponding protrusion of the second light guide body when the light beams entering the first light guide body travel to the bottom planes of the recesses. As a result, part of each of the light beams with improper incidence angle emitting from the light emitting plane is decreased.

Second, since the second light guide body of the light guide plate has a plurality of protrusions and the first cross-sectional planes of each of the protrusions parallel to the light emitting plane decrease gradually in the first direction towards the bottom plane of the corresponding recess, part of the light beam is refracted into one of the protrusions of the second light guide body and totally reflected at one of the side surfaces of the corresponding recess when the light beam entering the first light guide body travels to the bottom plane of the corresponding recess and passes the focus of the corresponding parabola (or circular paraboloid), so that the part of the light beam is emitted outside in a direction perpendicular to the light emitting plane. Thus, taken as a whole, the brightness of the backlight module of the embodiment of the invention compared with the conventional art is high at the direction perpendicular to the light emitting plane of the light guide plate.

Third, since the first cross-sectional planes of each of the protrusions of the light guide plate of the embodiment of the invention parallel to the light emitting plane decrease gradually in the first direction towards the bottom plane of the corresponding recess, the light guide plate of the embodiment of the invention is easily manufactured compared with the conventional art.

Forth, since the recesses and the protrusions are located inside of the light guide plate, compared with the conventional art, the recesses and the protrusions of the light guide plate of the embodiment of the invention do not scrape and damage optical films disposed above the light emitting plane of the light guide plate. The recesses and the protrusions of the light guide plate are not pressed to be deformed by other components disposed above the light emitting plane of the light guide plate.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessary limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate, comprising:
a first light guide body comprising a light incident plane, a first connection surface, and a plurality of recesses, wherein the recesses are disposed on the first connection surface, and each of the recesses has a bottom plane, and the light incident plane intersects with the first connection surface; and
a second light guide body comprising a light emitting plane, a second connection surface, and a plurality of protrusions, wherein the light emitting plane is opposite to the second connection surface, the first connection surface contacts the second connection surface, the bottom plane of each of the recesses is substantially parallel to the light emitting plane, the protrusions are disposed on the second connection surface and fill the recesses respectively, a plurality of first cross-sectional planes of each of the protrusions substantially parallel to the light emitting plane decrease gradually in a first direction towards the bottom plane of the corresponding recess, the first direction is perpendicular to the light emitting plane, a terminal thickness of the second light guide body is less than a terminal thickness of the first light guide body, and the refractive index of the second light guide body is greater than the refractive index of the first light guide body.

2. The light guide plate as claimed in claim 1, wherein the absolute value of the difference between the refractive index of the second light guide body and the refractive index of the first light guide body is between 0.03 and 0.4.

3. The light guide plate as claimed in claim 1, wherein the length of the bottom plane of each of the recesses is substantially parallel to the light incident plane and the specific value calculated by dividing the width of the bottom plane of each of the recesses by the depth of the same recess is between 0.1 and 10.

4. The light guide plate as claimed in claim 1, wherein each of the recesses further has two opposite side surfaces, and the bottom plane of each of the recesses connects the two side surfaces of the same recess.

5. The light guide plate as claimed in claim 4, wherein each of the side surfaces is a flat surface, a curved surface, composed of a plurality of flat surfaces, or composed of a plurality of curved surfaces.

6. The light guide plate as claimed in claim 4, wherein the side surfaces of each of the recesses are symmetric to each other.

7. The light guide plate as claimed in claim 4, wherein the side surfaces of each of the recesses and a second cross-sectional plane intersect with each other to form a locus, the locus is two parts of a parabola, the second cross-sectional plane is substantially perpendicular to the light emitting plane and the light incident plane, and the bottom plane of each of the recesses passes the focus of the corresponding parabola.

8. The light guide plate as claimed in claim 1, wherein each of the recesses is a groove and extends in a second direction substantially parallel to the light incident plane.

9. The light guide plate as claimed in claim 8, wherein an interval is defined between each two adjacent recesses, and the intervals decrease gradually in a third direction away from the light incident plane.

10. The light guide plate as claimed in claim 1, wherein each of the recesses is a hole, a plurality of recess groups are composed of the recesses, and the recesses of each of the recess groups are arranged in a second direction substantially parallel to the light incident plane.

11. The light guide plate as claimed in claim 10, wherein an interval is defined between each two adjacent recess groups, and the intervals decrease gradually in a third direction away from the light incident plane.

12. The light guide plate as claimed in claim 1, wherein each of the recesses further has a side surface encircling the bottom plane of the same recess, the side surface of each of the recesses is a part of a right circular conical surface, a part of a circular paraboloid or a part of a spheroid, and the bottom plane of each of the recesses is substantially perpendicular to a symmetry axis of the side surface of the same recess.

13. The light guide plate as claimed in claim 12, wherein the side surface of each of the recesses is a part of the circular paraboloid, and the bottom plane of each of the recesses passes the focus of the corresponding circular paraboloid.

14. The light guide plate as claimed in claim 1, wherein the first light guide body is a plate-shaped light guide body and the second light guide body is a plate-shaped light guide body.

15. The light guide plate as claimed in claim 14, wherein the specific value calculated by dividing the terminal thickness of the first light guide body by the terminal thickness of the second light guide body is between 10 and 100.

16. The light guide plate as claimed in claim 1, wherein the first light guide body is a wedge-shaped light guide body, and the second light guide body is a plate-shaped light guide body.

17. The light guide plate as claimed in claim 16, wherein of the specific value calculated by dividing the maximum terminal thickness of the first light guide body by the terminal thickness of the second light guide body is between 10 and 100, and the specific value calculated by dividing the minimum terminal thickness of the first light guide body by the terminal thickness of the second light guide body is between 3 and 30.

18. A backlight module comprising:
a light guide plate comprising:
a first light guide body comprising a light incident plane, a first connection surface, and a plurality of recesses, wherein the recesses are disposed on the first connection surface, and each of the recesses has a bottom plane, and the light incident plane intersects with the first connection surface; and
a second light guide body comprising a light emitting plane, a second connection surface, and a plurality of protrusions, wherein the light emitting plane is opposite to the second connection surface, the first connection surface contacts the second connection surface, the bottom plane of each of the recesses is substantially parallel to the light emitting plane, the protrusions are disposed on the second connection surface and fill the recesses respectively, a plurality of first cross-sectional planes of each of the protrusions substantially parallel to the light emitting plane decrease gradually in a first direction towards the bottom plane of the corresponding recess, the first direction is substantially perpendicular to the light emitting plane, and a terminal thickness of the second light guide body is less than a terminal thickness of the first light guide body and the refractive index of the second light guide body is greater than the refractive index of the first light guide body; and
a light source disposed beside the light incident plane.

19. The backlight module as claimed in claim 18, wherein the absolute value of the difference between the refractive index of the second light guide body and the refractive index of the first light guide body is between 0.03 and 0.4.

20. The backlight module as claimed in claim 18, wherein the length of the bottom plane of each of the recesses is substantially parallel to the light incident plane and the specific value calculated by dividing the width of the bottom plane of each of the recesses by the depth of the same recess is between 0.1 and 10.
